(19) United States
(12) Patent Application Publication
(10) Pub. No.: US 2026/0277517 A1
(43) Pub. Date: Sep. 17, 2026

(54) CLOUD PRINTING SERVICES

(71) Applicants: Tadao Yamasaki, Boulder, CO (US); Elena Doandes, Boulder, CO (US)

(72) Inventors: Tadao Yamasaki, Boulder, CO (US); Elena Doandes, Boulder, CO (US)

(73) Assignee: Ricoh Company, Ltd., Tokyo (JP)

(21) Appl. No.: 19/077,017

(22) Filed: Mar. 11, 2025

(51) Int. Cl. G06F 3/12

(52) U.S. Cl. CPC G06F 3/1287; G06F 3/1203; G06F 3/121; G06F 3/1234

(57) ABSTRACT

Apparatus, method, and software for a cloud printing service. In an embodiment, a print job manager of a cloud printing service is configured to receive print job information submitted by a user over a communication network, perform preprint processing on the print job information to detect a preprint problem, and perform a job approval procedure to interact with the user to resolve the preprint problem. The job approval procedure comprises operating a machine-learning model trained to generate a recommendation to resolve the preprint problem, providing an approval request to the user indicating the preprint problem and the recommendation, and receiving an approval response from the user approving the recommendation. The print job manager is configured to generate a print job based on the print job information modified according to the recommendation approved by the user, and provide the print job to a destination.

### TECHNICAL FIELD

The following disclosure relates to the field of printing, and more particularly, to printing services.

### BACKGROUND

Cloud printing services connect devices, such as smartphones, laptops, tablets, personal computers (PCs), etc., with one or more network-connected printers and/or other print devices. A user may access the cloud printing service to submit a print job to a network-connected printer. For example, a user may access a commercial cloud printing service to upload or submit a print file to print advertising or marketing materials, product manuals, books, invoices/bills, blueprints, mailings, etc. The cloud printing service, in turn, submits a print job to a printer capable of printing the print job. Some potential issues may arise regarding the submission to the cloud printing service.

### SUMMARY

Embodiments described herein provide enhanced proofing and/or approval of print jobs in a cloud printing service. As an overview, a user (or customer) uploads or submits a print file(s) to a cloud printing service, and the cloud printing service initiates a workflow to create or generate a print job in the cloud from the print file(s). There may be issues or questions regarding the uploaded print file(s). Thus, the cloud printing service may exchange comments or communications with the user to edit the print file(s) or other data associated with the submission by the user. In embodiments described herein, an apparatus referred to as a job approval engine is implemented as part of the cloud printing service to control interactions with the user. For example, the job approval engine may be configured to a perform a job approval procedure to interact with a user to resolve any preprint problems identified in a print job. In another example, the job approval engine may be configured to a perform a job approval procedure to interact with a user to improve production variables (e.g., printing cost, turnaround time, etc.). One technical benefit is the job approval engine provides a consistent and reliable process to interact with a user regarding submissions to the cloud printing service. Another technical benefit is the job approval engine may implement Artificial Intelligence (AI) or Machine-Learning (ML) techniques to provide recommendations to the users regarding submissions, which can improve the experience of the user in utilizing the cloud printing service.

In an embodiment (also referred to as aspects), an apparatus comprises a print job manager of a cloud printing service provisioned on a cloud-computing platform. The print job manager comprises at least one processor and memory configured to cause the print job manager at least to: receive print job information submitted by a user over a communication network, perform preprint processing on the print job information to detect a preprint problem, and perform a job approval procedure to interact with the user to resolve the preprint problem. The job approval procedure comprises operating at least one machine-learning model trained to generate a recommendation to resolve the preprint problem, providing an approval request to the user indicating the preprint problem and the recommendation to resolve the preprint problem generated by the at least one machine-learning model, and receiving an approval response from the user approving the recommendation generated by the at least one machine-learning model. The at least one processor and memory are configured to cause the print job manager at least to: generate a print job based on the print job information modified according to the recommendation approved by the user, and provide the print job to a destination corresponding with at least one print device over the communication network.

In an embodiment, a method of handling print jobs, in a cloud print service provisioned on a cloud-computing platform, comprises: receiving print job information submitted by a user over a communication network, performing preprint processing on the print job information to detect a preprint problem, and performing a job approval procedure to interact with the user to resolve the preprint problem. The job approval procedure comprises operating at least one machine-learning model trained to generate a recommendation to resolve the preprint problem, providing an approval request to the user indicating the preprint problem and the recommendation to resolve the preprint problem generated by the at least one machine-learning model, and receiving an approval response from the user approving the recommendation generated by the at least one machine-learning model. The method further comprises generating a print job based on the print job information modified according to the recommendation approved by the user; and providing the print job to a destination corresponding with at least one print device over the communication network.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 illustrates a cloud printing architecture.

FIG. 2 illustrates another cloud printing architecture in an illustrative embodiment.

FIG. 3 is a block diagram of a cloud printing service in an illustrative embodiment.

FIG. 4 is a block diagram of a customer portal in an illustrative embodiment.

FIG. 5 is a block diagram of a producer portal in an illustrative embodiment.

FIG. 6 is a block diagram of a print job manager in an illustrative embodiment.

FIG. 7 is a message diagram illustrating communications between a cloud printing service and a user in an illustrative embodiment.

FIGS. 8A-8B are flow charts illustrating a method of handling a print job in an illustrative embodiment.

FIG. 9 is a block diagram illustrating at least a portion of a workflow in an illustrative embodiment.

FIG. 10 is a block diagram of a print job manager in an illustrative embodiment.

FIG. 11 is a block diagram illustrating interpretation of free-form text in an illustrative embodiment.

FIG. 12 is a block diagram of a job approval engine in an illustrative embodiment.

FIG. 13 is a schematic diagram illustrating training and deployment of machine learning models in an illustrative embodiment.

FIG. 14 is a message diagram illustrating communications between a cloud printing service and a user in an illustrative embodiment.

FIGS. 15A-15C are flow charts illustrating a method of handling a print job in an illustrative embodiment.

FIG. 16 is a block diagram of a job approval engine in an illustrative embodiment.

FIGS. 17A-17B are message diagrams illustrating communications with a cloud printing service in an illustrative embodiment.

FIG. 18 is a schematic diagram illustrating training and deployment of machine learning models in an illustrative embodiment.

FIG. 19 illustrates a processing system operable to execute a computer readable medium embodying programmed instructions to perform desired functions in an illustrative embodiment.

### DETAILED DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

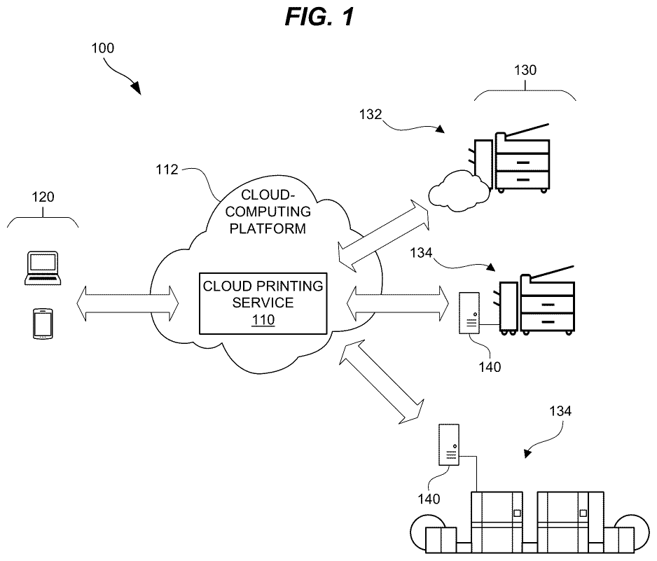

FIG. 1 illustrates a cloud printing architecture 100. Cloud printing architecture 100 comprises a cloud printing service 110 implemented on a cloud-computing platform 112. Cloud-computing allows users access to a variety of services over an internet connection. Some examples of cloud-computing platform 112 may comprise Amazon Web Services (AWS), Google Cloud, Microsoft Azure, etc. Cloud printing service 110 connects end user devices 120 (e.g., a smartphone, laptop, tablet, personal computer (PC), etc.) with one or more network-connected printers 130. An end user device 120 may also be referred to as a client device, a customer device, a host device, etc. A printer 130 used in cloud printing architecture 100 may comprise a cloud-ready or cloud-enabled printer 132 configured to communicate with the cloud printing service 110. A printer 130 used in cloud printing architecture 100 may comprise a non-cloud-enabled or legacy printer 134 that uses a cloud print mediator 140, for example, to communicate with the cloud printing service 110. A printer 130 may be a continuous-form printer, a cut-sheet printer, a wide-format printer, a Multi-Function Peripheral (MFP), a 3-D printer, etc. A printer 130 is configured to receive a submission in the form of a print job, and process the print job to produce printed material. A print job is a unit of work to be run on a printer 130. A print job may comprise one or more print files (e.g., a Portable Document Format (PDF) file), may comprise job information such as a job ticket (e.g., a Job Definition Format (JDF) job ticket) containing instructions to process and print a job, etc. Although printers are discussed herein, any image forming apparatuses may be used. In general, an image forming apparatus is an apparatus that performs image formation (printing) on a recording or printable medium by applying colorants or marking/recording material on the basis of print data.

When an end user device 120 is remote from a printer 130 (i.e., not directly or physically connected), the cloud printing service 110 acts as an intermediary to receive one or more print files from the end user device 120, and submit a print job to the printer 130. For example, cloud printing service 110 may be used for consumer-based cloud printing, where end user devices 120 of an entity submit print jobs through the cloud printing service 110 to a printer 130 owned by the entity. Cloud printing service 110 may be used for professional or commercial cloud printing, where end user devices 120 submit print jobs through the cloud printing service 110 to printers 130 implemented at production facilities (e.g., corporate facilities, commercial facilities, etc.). One benefit is a user is able to submit print jobs from virtually anywhere an internet connection is available.

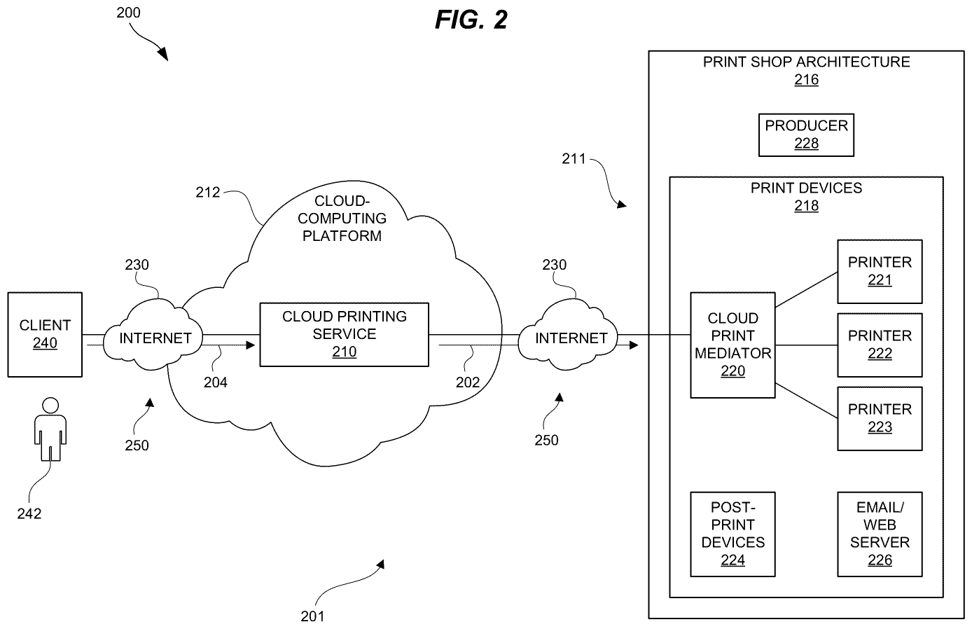

FIG. 2 illustrates another cloud printing architecture 200 in an illustrative embodiment. In this embodiment, cloud printing architecture 200 comprises a cloud printing service 210 implemented on a cloud-computing platform 212, and the cloud printing service 210 may be configured for professional, commercial, production, or industrial printing. Commercial printing may be performed by Print Service Providers (PSP) or other providers that offer printing services to users/customers in exchange for monetary compensation. For example, a PSP may offer printing services for advertising or marketing materials, product manuals, books, invoices/bills, blueprints, mailings, etc. In general, a PSP or print shop (and/or an owner or operator of a PSP/print shop) may be referred to as a producer 228 that subscribes to or uses a cloud printing service 210. In FIG. 2, a print shop architecture 216 may include or operate a variety of printing equipment or printing resources, referred to generally as print devices 218. The print devices 218 may include one or more printers 221-223, one or more post-print devices 224 or finishing devices (e.g., binding, stapling, stitching, cutting/trimming, folding, creasing, sorting, hole punching, etc.), email or web-publishing servers 226, etc. Although not shown in FIG. 2, a printer 221-223 generally includes a print controller and one or more print engines. The print controller receives a printer-compliant print stream (e.g., PDL-compliant data), generates rasterized data from the printer-compliant print stream, and transmits the rasterized data to one or more print engines, which mark a printable media with the rasterized data. The print engine may use a variety of marking materials for marking a printable media, such as ink (e.g., water, solvent, oil, or UV-curable), oil-based paints, additive manufacturing materials, toner, etc. The printable media may comprise any type of material upon which ink or another type of marking material is applied, such as paper, plastic, card stock, transparent sheets, a substrate for 3D printing, cloth or fabric, etc.

Print shop architecture 216 may implement multiple printers of the same type, or may implement different types of printers depending on the needs of the customers. For example, one or more of the printers 221-223 may comprise a production printer (e.g., continuous-feed inkjet printer, a cut-sheet printer, etc.), a desktop printer, a 3D printer, a plotter or wide-format printer, etc. One or more printers 221-223 may be configured to print on different types or forms of printable media, such as standard weight paper, glossy or matte stock, cut-sheet, continuous-forms, etc. One or more printers 221-223 may be configured to print on different media sizes, such as letter, legal, A4, extra-large, etc. One or more printers 221-223 may be configured to print in different colors, such as color or monochrome. One or more printers 221-223 may be configured with different finishing or post-print options (e.g., post-print devices 224), such as glosses or textures, binding, cutting/trimming, embossing, laminating, etc. Thus, each printer 221-223 may have different device capabilities (DEVCAPS) that are provided to the cloud printing service 210.

Printers 221-223 are shown as being at a common location (e.g., existing within the confines of the print shop itself) in the example of FIG. 2, but printing equipment may be distributed among multiple, different locations in other examples. The print shop resources illustrated in FIG. 2 are merely meant to provide an example of the variety of print shop resources that may be provided.

Cloud printing architecture 200 in FIG. 2 may be considered a hybrid cloud architecture 201 that combines the infrastructure of a public cloud (illustrated by cloud-computing platform 212), and on-ground or on-premise infrastructure 211. The on-premise infrastructure 211 comprises one or more print devices 218, such as for a print shop. In general, “on-premises” means that the infrastructure exists on-site in contrast to being hosted off-site, such as in a public cloud. In an on-premise infrastructure 211, an entity owns the resources of the infrastructure (e.g., computing resources, networking, storage, software, etc.), and/or has full control over the resources. In an embodiment, the print devices 218 may include one or more cloud print mediators 220 that interface printers 221-223 with the cloud printing service 210. A cloud print mediator 220 and a printer 221-223 may collectively be referred to as a print system. A cloud print mediator 220 is an information processing apparatus, and comprises a type of on-premise equipment configured to interface one or more printers 221-223 with a cloud printing service 210. Cloud print mediator 220 is communicatively coupled to a cloud printing service 210, and is also communicatively coupled to one or more printers 221-223. For example, cloud print mediator 220 may be directly connected to one or more printers 221-223 via wired or wireless connections, and is connected to the cloud printing service 210 over one or more network (e.g., internet) connections. Thus, printers 221-223 may be decoupled or isolated from the cloud print service 210 through the cloud print mediator 220.

At a high level, a client 240 of a user 242 (or customer) may submit one or more print files 204 to the cloud printing service 210. A print file 204 (e.g., PDF file) as described herein comprises printable content (e.g., text, images, graphics, etc.), layout information, associated job attributes (e.g., media size, number of copies, color or greyscale, resolution, etc.), and/or other data. A client 240 may comprise a program, a software application, a web page, etc., configured to upload or submit a print file(s) 204 to the cloud printing service 210, and which may be executed on an end user device 120. A client 240 may serve a user 242 such as a bank, a credit card company, and/or another customer having printing and/or document delivery needs (e.g., monthly bank statements, monthly credit card bills, etc.). A client 240 may serve a user 242 with digital printing and/or publishing needs (e.g., e-mail services, web publishing services, etc.). The cloud printing service 210 pre-processes the print file(s) 204 (also referred to as pre-flight) to confirm that the print file(s) 204 is present, valid, correctly formatted, and/or of the desired type, and may correct any potential problems. The cloud printing service 210 may then create a print job 202 from the print file(s) 204, identify or select one or more destinations for the print job 202 (e.g., one or more of the printers 221-223, a hot folder, etc.), and send the print job 202 to the destination(s). For example, cloud printing service 210 may submit the print job 202 to a cloud print mediator 220 for printing on a printer under its domain (i.e., supervised by the cloud print mediator 220).

Print devices 218 are shown in FIG. 2 as being able to communicate with the cloud printing service 210 over a communication network 250, such as the internet 230. Likewise, client 240 is shown as being able to communicate with the cloud printing service 210 over a communication network 250, such as the internet 230. The internet 230 as referred to herein is a system of interconnected computer networks that uses the Internet Protocol suite (e.g., Transmission Control Protocol/Internet Protocol (TCP/IP)) to communicate between networks and devices, although other protocols may be developed in the future.

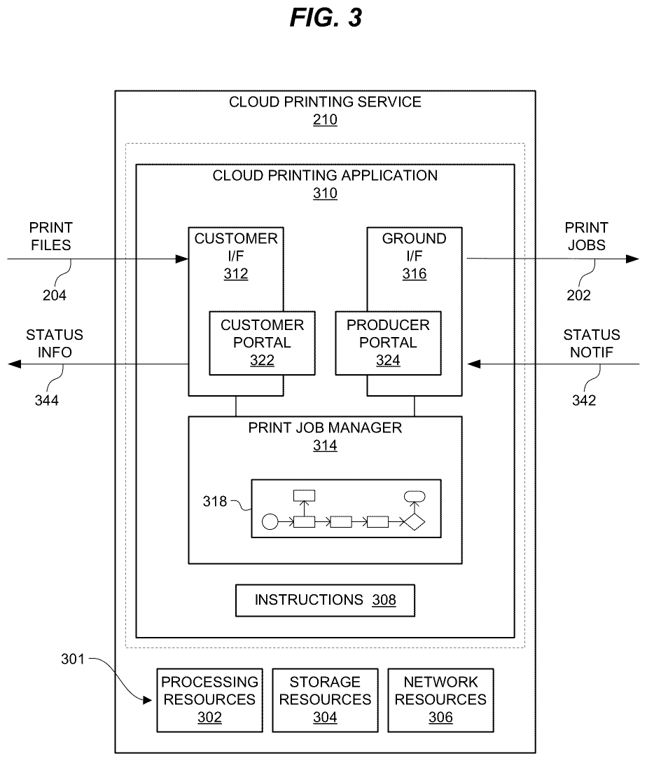

FIG. 3 is a block diagram of a cloud printing service 210 in an illustrative embodiment. To implement the cloud printing service 210, cloud resources 301 are provisioned in a cloud-computing environment (e.g., AWS), such as processing resources 302, storage resources 304, and/or network resources 306, although other resources are considered herein. A cloud printing application 310 may be built or executed on the provisioned resources with instructions 308, programming, code, etc.

In general, cloud printing application 310 receives one or more print files 204 from a user 242, and initiates a workflow to create or generate a print job 202 in the cloud from the print file(s) 204. The cloud printing application 310 submits the print job 202 to one or more print devices 218 (e.g., printer 221-223) for printing. The cloud printing application 310 receives status notifications 342 regarding the print job 202 and/or print devices 218 processing the print job 202, and may provide status information 344 to the user 242 indicating progress of the print job 202. As part of the workflow used to create the print job 202, cloud printing application 310 may perform proofing and/or approval of print jobs 202. In the proofing and/or approval of print jobs 202, there may be issues or questions regarding the uploaded print file(s) 204, and cloud printing application 310 may be configured to exchange comments or communications with the user 242 to edit the print file(s) 204 or other data in creation of the print job 202.

In an embodiment, cloud printing application 310 provides a customer interface (I/F) 312 (also referred to as a user interface), a print job manager 314, and a ground interface 316. Customer interface 312 is a module or component of the cloud printing service 210 that interacts with users 242. For example, customer interface 312 may receive print files 204 uploaded or submitted by users 242 to the cloud printing service 210, such as through a client 240. Customer interface 312 may provide status information 344 for print jobs 202 to a user 242. Customer interface 312 may communicate with a user 242 through email, File Transfer Protocol (FTP), or through another means. In an embodiment, cloud printing application 310, such as through customer interface 312, may provide a website, a portal, a dashboard, a Graphical User Interface (GUI), or some other digital or graphical interface configured to interact with a user 242. For example, cloud printing application 310 may provide a customer portal 322 that allows a user 242 access to the cloud printing service 210. Cloud printing application 310 may be implemented in a multi-tenant cloud environment that is used by multiple different customers. Thus, each customer may be provided with a separate, secure space for accessing the cloud printing service 210 through customer portal 322.

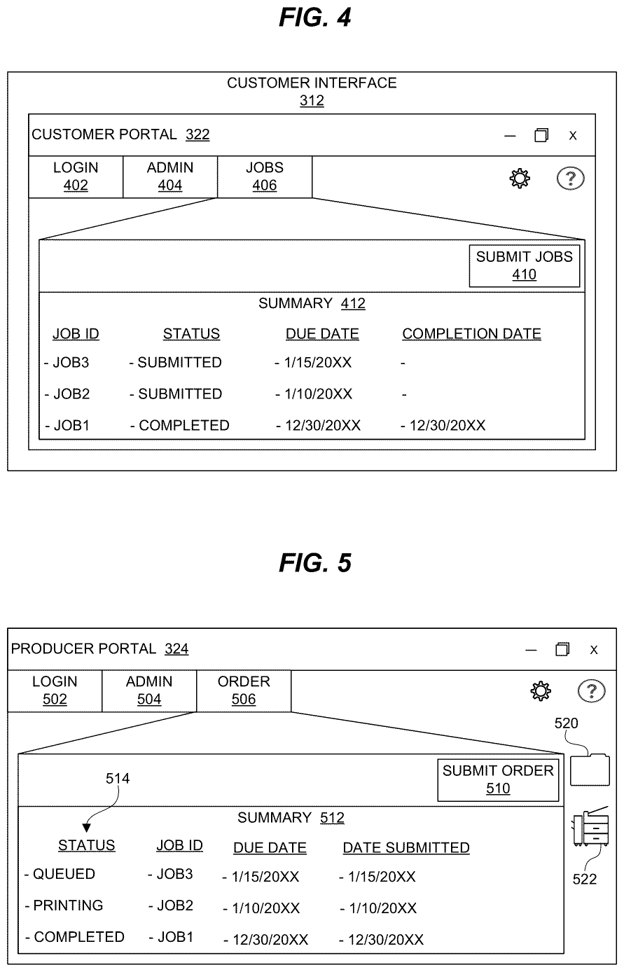

FIG. 4 is a block diagram of a customer portal 322 in an illustrative embodiment. Customer portal 322 may include icons, graphic representations or graphical elements, windows, screens, pages, etc., for interacting with a user 242. For example, customer portal 322 may provide a login page 402 (or window, screen, icon, etc.) configured to authenticate a user 242 for the cloud printing service 210. Customer portal 322 may provide an administration page 404 configured to allow a user 242 to define settings for the cloud printing service 210. Customer portal 322 may provide a jobs page 406 configured to allow a user 242 to manage print jobs 202 within the cloud printing service 210. For example, jobs page 406 may comprise a submit jobs graphical element 410 or button selectable by the user 242 to submit or upload one or more print files 204 to the cloud printing service 210, define one or more job attributes associated with the print files 204, etc. Jobs page 406 may also comprise a summary graphical element 412 summarizing one or more print jobs 202 submitted to the cloud printing service 210, such as a job identifier (ID) or name, status information, a due date, a completion date, etc. However, jobs page 406 and/or customer portal 322 may have other formats or content as desired to manage print jobs 202 in the cloud printing service 210.

In FIG. 3, a print job manager 314 is configured to manage workflows 318 for print jobs 202 in the cloud printing service 210. Print job manager 314 may implement a workflow controller to generate workflows 318 for incoming print jobs 202. The workflows 318 may be generated based on workflow rules for a user, a print shop, etc., based on job attributes associated with a print files 204, activities available at a print shop, etc. For example, a workflow 318 may be configured to scan incoming print files 204 for malware, extract metadata or job attributes from the print files 204, convert the print files 204 to a standard format (e.g., .pdf), preflight the print files 204 to identify any potential problems or issues, identify printers 221-223 available and/or capable of printing print jobs 202, schedule print jobs 202 directed to specific printers 221-223 (e.g., based on input from a producer 228), etc.

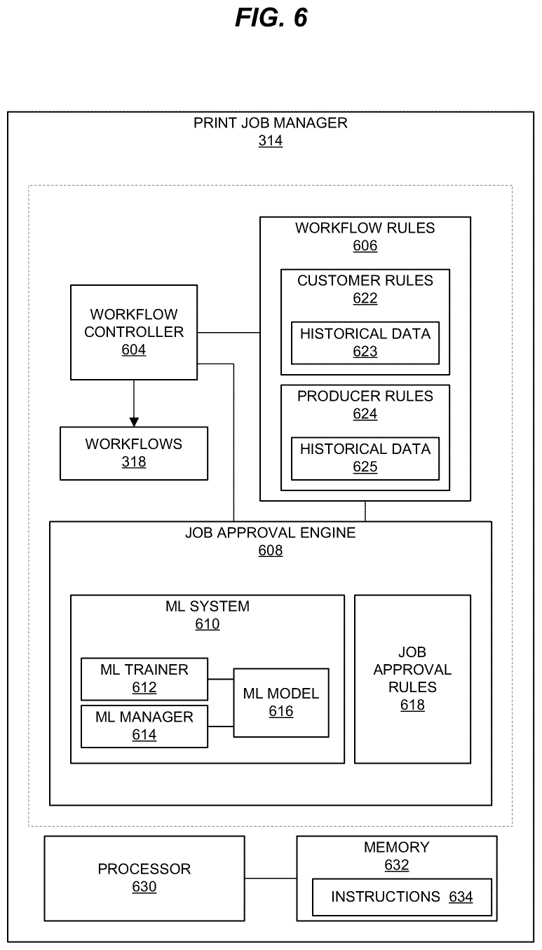

In an embodiment, cloud printing application 310, such as through print job manager 314 or ground interface 316, may provide a website, a portal, a dashboard, a GUI, or some other digital or graphical interface configured to interact with a producer 228 (e.g., a PSP operator). For example, cloud printing application 310 may provide a producer portal 324 that allows a producer 228 access to the cloud printing service 210. FIG. 5 is a block diagram of a producer portal 324 in an illustrative embodiment. For example, producer portal 324 may provide a login page 502 (or window, screen, icon, etc.) configured to authenticate a producer 228 for the cloud printing service 210. Producer portal 324 may provide an administration page 504 configured to allow a producer 228 to define settings for the cloud printing service 210. Producer portal 324 may provide an order page 506 configured to allow a producer 228 to manage and/or order printing of print jobs 202 through the cloud printing service 210. For example, order page 506 may comprise a submit order graphical element 510 or button selectable by the producer 228 to print one or more print jobs 202 from the cloud printing service 210 to one or more printers 221-223. Producer 228 may drag and drop print jobs 202 into a hot folder icon 520, a printer icon 522 associated with a specific printer 221-223, etc. Order page 506 may also comprise a summary graphical element 512 summarizing one or more print jobs 202 submitted through the cloud printing service 210, such as status information 514, a job ID or name, a due date, a submission date, etc. Of note, the status information 514 is updated based on the status notifications provided to the cloud printing service 210. Although one example is shown, order page 506 and/or producer portal 324 may have other formats or content as desired.

In FIG. 3, ground interface 316 is a module or component of the cloud printing service 210 that interacts with on-premise infrastructure 211, such as one or more print devices 218. For example, ground interface 316 may submit a print job 202, a print request, an instruction, control information, etc., (generally referred to as a print job 202) from the cloud printing service 210 to one or more print devices 218. For example, ground interface 316 may submit a print job 202 to a cloud print mediator 220 that is scheduled for printing at an associated printer 221-223 under the domain of the cloud print mediator 220. Ground interface 316 may receive status notifications 342 (also referred to as status updates) from one or more print devices 218 regarding the status of print jobs 202, the status of print devices 218 (e.g., printers 221-223), etc. Print job manager 314 may use the status notifications 342 to update the status information 514 presented at the producer portal 324, and customer interface 312 may use the status notifications 342 to provide status information 344 to the user 242 through customer portal 322.

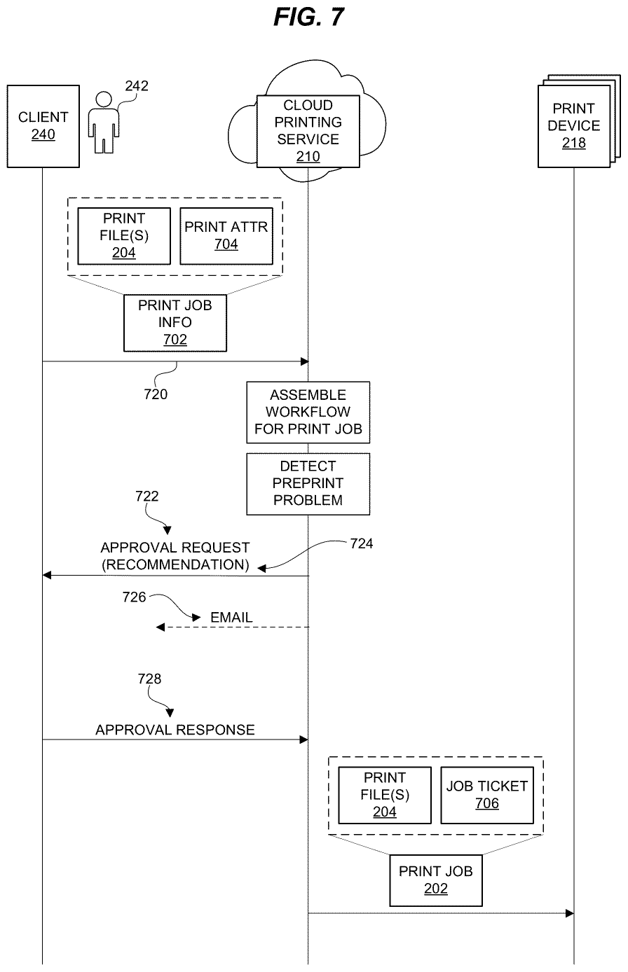

FIG. 6 is a block diagram of print job manager 314 in an illustrative embodiment. Print job manager 314 comprises a workflow controller 604, which is an information processing apparatus comprising circuitry, logic, hardware, an application, means, etc., configured to generate workflows 318 for handling print jobs 202 in the cloud (i.e., as part of the cloud printing service 210 on cloud-computing platform 212). Workflow controller 604 may operate based on or in conjunction with workflow rules 606, which are rules or policies used in assembling or generating a workflow 318. The workflow rules 606 may comprise customer rules 622 that are tailored or customized for a user or customer. For example, customer rules 622 may specify specific preflighting, email notification when printing is complete, reporting if printing time and/or cost exceeds a threshold, etc. The customer rules 622 may include historical data 623 for the customer regarding processing of prior print jobs. The workflow rules 606 may comprise producer rules 624 that are tailored or customized for a producer, print shop, etc. The producer rules 624 may include historical data 625 for the producer regarding processing of prior print jobs.

As described above, as part of proofing and/or approval of print jobs 202, there may be issues or questions regarding the uploaded print file(s) 204 or associated data. Thus, workflow processing may include exchanging comments or communications with a user 242 to edit the print file(s) 204 or other data associated with the submission by the user 242. Print job manager 314 comprises a job approval engine 608, which is an information processing apparatus comprising circuitry, logic, hardware, an application, means, etc., configured to control interactions with users 242 (e.g., seek input from a user or customer) regarding processing of a print job 202. For example, job approval engine 608 may initiate an exchange with a user or customer to request approval for editing or modifying a print file(s) 204 or print job 202 created based on a print file 204. In an embodiment, job approval engine 608 may implement one or more Artificial Intelligence (AI) or Machine Learning (ML) systems. As illustrated in FIG. 6, job approval engine 608 may implement an ML system 610 for analyzing print jobs and/or other data related to printing. An ML system 610 may comprise circuitry, logic, hardware, software, means, etc., configured to use machine learning or artificial intelligence techniques to perform functions described for job approval engine 608. In an embodiment, one or more ML models 616 are trained for ML system 610. In general, an ML model 616 is a program or algorithm that learns from training samples to make predictions or recommendations based on a set of input data, and/or perform other functions. ML system 610 may further include an ML trainer 612 and an ML manager 614. ML trainer 612 may comprise circuitry, logic, hardware, means, etc., configured to train and/or re-train one or more ML models 616. ML manager 614 may comprise circuitry, logic, hardware, means, etc., configured to manage one or more ML models 616 as trained. For example, ML manager 614 may be configured to input data into an ML model 616 during testing or after deployment, and receive output from the ML model 616, along with other functions. Job approval engine 608 may also operate based on or in conjunction with job approval rules 618, which are rules or policies defining how print jobs are approved in the cloud (i.e., as part of the cloud printing service 210 on cloud-computing platform 212) before submission of the print jobs to one or more print devices 218, such as a cloud print mediator 220, a printer 221-223, etc. The job approval rules 618 may at least partially overlap with the workflow rules 606.

One or more of the subsystems of print job manager 314 may be implemented on cloud resources 301, which are ultimately delivered by one or more hardware platforms comprised of analog and/or digital circuitry. For example, one or more of the subsystems of print job manager 314 may be implemented on a processor 630 (cloud-based) that executes instructions 634 stored in memory 632. A processor 630 comprises an integrated hardware circuit configured to execute instructions 634 to provide the functions of print job manager 314. Processor 630 may comprise a set of one or more processors or may comprise a multi-processor core, depending on the particular implementation. Memory 632 (cloud-based) is a non-transitory computer readable medium for data, instructions, applications, etc., and is accessible by processor 630. Memory 632 is a hardware storage device capable of storing information on a temporary basis and/or a permanent basis. Memory 632 may comprise a random-access memory, or any other volatile or non-volatile storage device. Print job manager 314 may comprise various other components not specifically illustrated in FIG. 6.

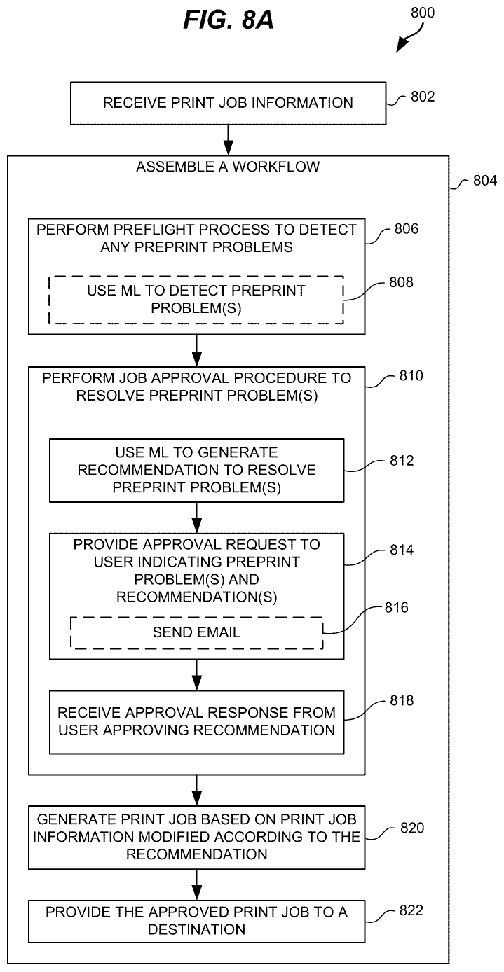

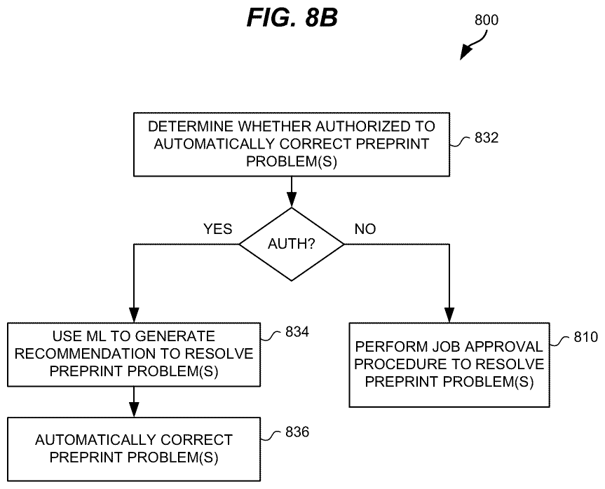

FIG. 7 is a message diagram illustrating communications between cloud printing service 210 and a user 242 in an illustrative embodiment. FIGS. 8A-8B are flow charts illustrating a method 800 of handling a print job in an illustrative embodiment. The steps of method 800 will be described with reference to print job manager 314 in FIG. 6, but those skilled in the art will appreciate that method 800 may be performed in other systems or devices. Also, the steps of the flow charts described herein are not all inclusive and may include other steps not shown, and the steps may be performed in an alternative order.

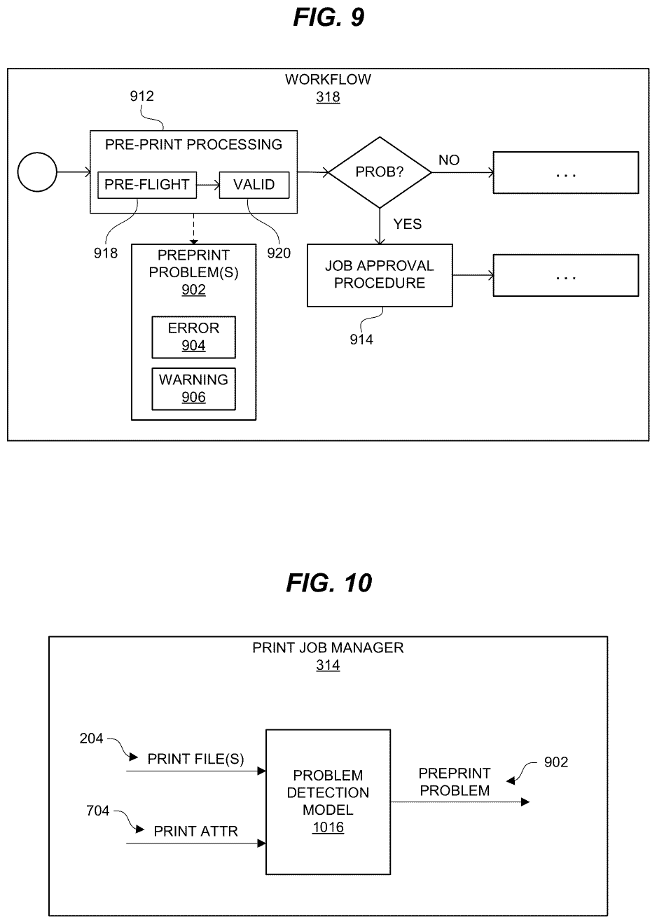

In operation, print job manager 314 receives print job information 702 submitted by a user 242 over a communication network 250 (see step 802 in FIG. 8A). As illustrated in FIG. 7, print job manager 314 receives a job submission 720 (also referred to as a print submission) comprising the print job information 702 in digital form from a client 240 operated by a user 242. For example, print job manager 314 may receive the print job information 702 in an email, via a transport protocol (e.g., FTP), through a customer portal 322, or through another means. The print job information 702 may comprise one or more print files 204, one or more print attributes 704 (also referred to as job attributes, print settings, etc.), and other job-related information. In response to receiving the print job information 702, print job manager 314 assembles a workflow 318 to create or generate a print job 202 based on the print job information 702 (see step 804 of FIG. 8A). FIG. 9 is a block diagram illustrating at least a portion of a workflow 318 in an illustrative embodiment. According to the workflow 318, print job manager 314 may perform preprint processing 912 on the print job information 702 to detect a preprint problem(s) 902 (see step 806 in FIG. 8A). Preprint processing 912 is a process of reviewing or analyzing print data or content, attributes, and/or information for errors 904, warnings 906, etc., before actual printing. Preprint processing 912 may include a preflight process 918 (also referred to as preflight or preflighting) configured to detect any problems related to a print file(s) 204. Preprint processing 912 may include a validation process 920 configured to validate print attributes 704 or job information. An error, problem, warning, etc., detected during preprint processing 912 is referred to generally as a preprint problem 902 or a preprint issue. One benefit of using preprint processing 912 in a workflow 318 is printing runs may be expensive, may consume a large amount of printable media, may require complex post-printing (e.g., binding), etc. Catching preprint problems 902 before printing of a print file(s) 204 helps to avoid costly and time-consuming reprints.

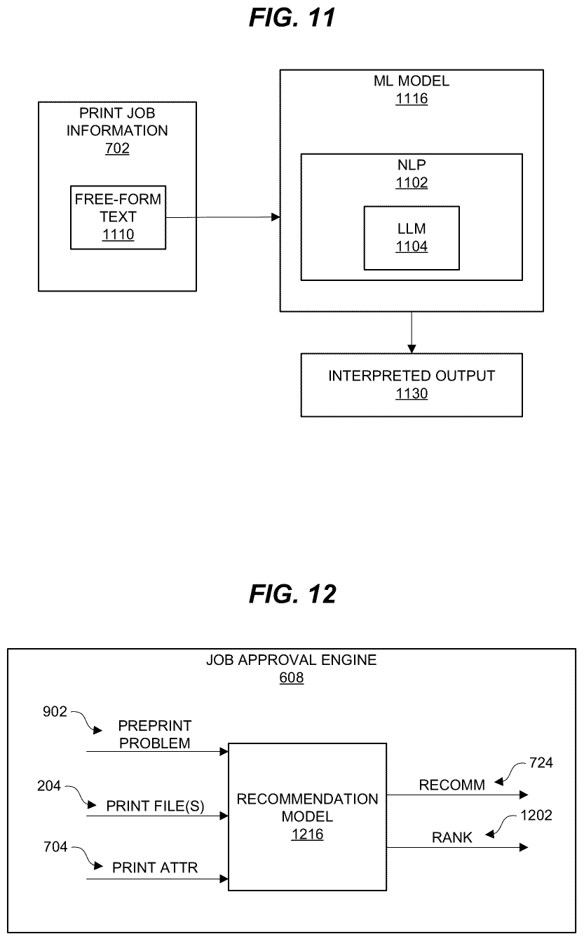

In an embodiment, print job manager 314 may operate a machine-learning (ML) model trained to detect a preprint problem(s) 902 associated with a print file(s) 204 (see optional step 808 in FIG. 8A). FIG. 10 is a block diagram of print job manager 314 in an illustrative embodiment. An ML or AI model referred to as a problem detection model 1016 is trained to provide certain output based on input data. In an embodiment, the input data to the problem detection model 1016 may comprise one or more print files 204, one or more print attributes 704, and/or other print job information 702, although other input data may be used. The (trained) problem detection model 1016 may generate, as output, an indication or indications of a preprint problem 902 detected in the print job information 702. One technical benefit is the problem detection model 1016 may provide improved accuracy and efficiency in detecting preprint problems 902.

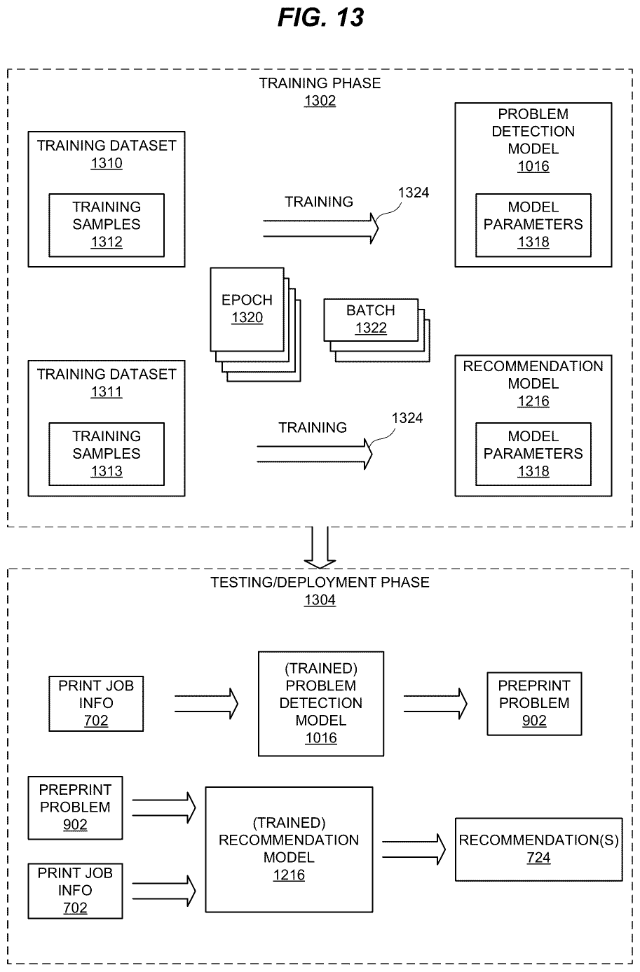

As part of the preprint processing 912, the print job information 702 may include free-form text specified by the user 242. FIG. 11 is a block diagram illustrating interpretation of free-form text 1110 in an illustrative embodiment. Free-form text 1110 is unstructured text data entered by a user, such as in a text field. For example, a user 242 may enter free-form text 1110 into a text field of a customer portal 322 specifying print job information 702, such as one or more print attributes 704. In an embodiment, print job manager 314 may operate or implement a ML model 1116 to interpret the free-form text 1110. ML model 1116 may be trained to interpret human language. Some examples of ML model 1116 are a Natural Language Processing (NLP) model 1102, a Large Language Model (LLM) 1104, etc. Thus, ML model 1116 may be implemented to interpret the free-form text 1110, and generate interpreted output 1130 indicating the interpretation of the free-form text 1110. One technical benefit is the ML model 1116 may provide improved accuracy and efficiency in interpreting information submitted to a user 242.

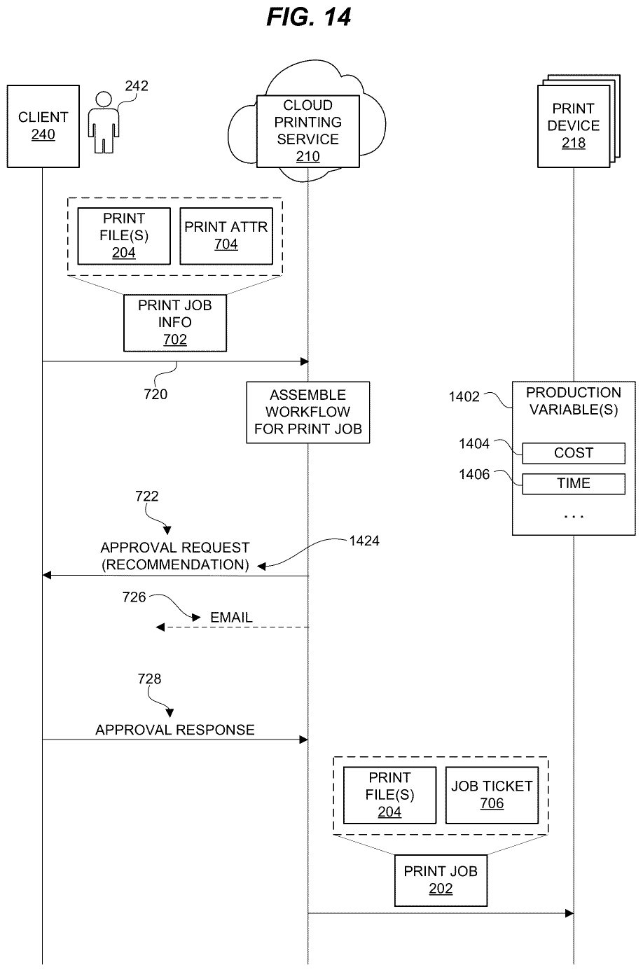

As part of the preprint processing 912, print job manager 314 may automatically correct certain preprint problems 902 detected in the print job information 702 based on workflow rules 606. However, print job manager 314 may not be able to automatically correct other preprint problems 902 detected in the print job 202. In FIG. 8B, for example, print job manager 314 may determine whether it is authorized to automatically correct a preprint problem 902 (see optional step 832 in FIG. 8B), such as based on job approval rules 618. When authorized to automatically correct the preprint problem 902, print job manager 314 may operate a recommendation model 1216 (see FIG. 12) to generate a recommendation to resolve or correct the preprint problem 902 (see optional step 834 in FIG. 8B), and automatically or autonomously correct the preprint problem 902 based on the recommendation (see optional step 836 in FIG. 8B), such as without further interaction with the user 242. One technical benefit is the recommendation model 1216 may provide improved accuracy and efficiency in identifying resolutions to preprint problems 902. When not authorized to automatically correct the preprint problem 902, print job manager 314 may interact with the user 242 (e.g., return the print file(s) 204 to the user 242, obtain additional information from the user 242, etc.). As in FIG. 9, when a preprint problem 902 is detected that requires or necessitates user input (based on the job approval rules 618), print job manager 314 triggers, initiates, or performs a job approval procedure 914 to interact with the user 242 to resolve the preprint problem 902 (see step 810 in FIGS. 8A-8B).

For the job approval procedure 914 in FIG. 8A, print job manager 314 may operate a ML model 616 trained to generate a recommendation 724 to resolve or correct the preprint problem 902 (see step 812 in FIG. 8A). FIG. 12 is a block diagram of job approval engine 608 in an illustrative embodiment. A ML or AI model referred to as a recommendation model 1216 is trained to provide certain output based on input data. In an embodiment, the input data to the recommendation model 1216 may comprise an indication of the preprint problem 902. In an embodiment, the input data to the recommendation model 1216 may comprise one or more print files 204, one or more print attributes 704, and/or other print job information 702. The (trained) recommendation model 1216 may generate, as output, a recommendation 724 to resolve or correct a preprint problem 902. In an embodiment, the recommendation 724 may be based at least partially on historical data 623 for the user 242, historical data 625 for the producer 228, etc. One technical benefit is the cloud printing service 210 provides guidance to the user 242 as to how to correct the preprint problem 902. In an embodiment, the (trained) recommendation model 1216 may generate, as output, a plurality of recommendations 724 to resolve or correct a preprint problem 902. One technical benefit is the recommendation model 1216 may provide options to the user 242 as to how to correct the preprint problem 902. In an embodiment, the (trained) recommendation model 1216 may generate, as output, rankings 1202 of the recommendations 724. One technical benefit is the rankings 1202 may assist the user 242 in selecting a recommendation 724.

Print job manager 314 provides or sends an approval request 722 to the user 242 (see step 814 in FIG. 8A). The content of the approval request 722 may vary as desired. In an embodiment, the approval request 722 may indicate the preprint problem 902 and a recommendation 724 to resolve or correct the preprint problem 902. In an embodiment, the approval request 722 may indicate the preprint problem 902 and a plurality of recommendations 724 to resolve or correct the preprint problem 902. In an embodiment, the approval request 722 may indicate the preprint problem 902, a plurality of recommendations 724 to resolve or correct the preprint problem 902, and rankings 1202 of the recommendations 724. When a print file 204 comprises a PDF file, for example, print job manager 314 may annotate the PDF file based on the recommendation(s) 724, and provide the annotated PDF file to the user 242 with the approval request 722. In an embodiment, print job manager 314 may send an email 726 to the user 242 (see optional step 816 in FIG. 8A) containing the approval request 722, or comprising a link to a portal (e.g., customer portal 322) of the cloud printing service 210 configured to display the preprint problem 902, the recommendation(s) 724, the rankings 1202, and/or other data. One technical benefit of using email 726 for the approval request 722 is a consistent and reliable process is defined for interacting with a user 242 regarding submissions to the cloud printing service 210.

On their end, the user 242 may approve, reject, or modify the proposal in the approval request 722. Thus, the user 242 determines whether to accept a recommendation 724 of the print job manager 314, whether to propose or request another resolution to the preprint problem 902, etc., and provides or sends an approval response 728 to the print job manager 314. The content of the approval response 728 may vary as desired. In an embodiment, the approval response 728 may indicate acceptance of a recommendation 724 provided in an approval request 722. In an embodiment, the approval response 728 may indicate a selected recommendation 724 from a plurality of recommendations 724 provided in an approval request 722. In an embodiment, the approval response 728 may indicate an alternate resolution to the preprint problem 902. Although a single request/response exchange is illustrated in FIG. 7 as an example, there may be multiple exchanges between the user 242 and the print job manager 314 for a job approval procedure 914.

Print job manager 314 receives the approval response 728 from the user 242 (see step 818 in FIG. 8A). After approving a recommendation 724 generated by recommendation model 1216, print job manager 314 generates, creates, or produces a print job 202 (i.e., an approved print job) based on print job information 702 modified according to the approved recommendation 724 (see step 820 in FIG. 8A). For example, print job manager 314 may change, modify, or alter the print file(s) 204, print attribute(s) 704, and/or other print job information 702 according to the approved recommendation 724. In another example, the approval response 728 may contain modified print job information 702 modified by the user 242 according to the approved recommendation 724, such as a modified print file(s) 204, print attribute(s) 704, and/or other print job information 702. Print job manager 314 (e.g., through ground interface 316) provides or sends the print job 202 to a destination corresponding with at least one of the print devices 218 over the communication network 250 (see step 822 in FIG. 8A). The print job 202 may comprise one or more print files 204, a job ticket 706 (e.g., Job Definition Format (JDF) job ticket or file) describing attributes for printing the print job 202 (e.g., media size, number of copies, color or greyscale, resolution, etc.), and/or other job-related information. For example, print job manager 314 may send a message to the destination comprising the print job 202, may load the print job 202 to a storage location associated with a Uniform Resource Locator (URL), etc. One technical benefit is the print job manager 314 obtains approval from the user 242 to resolve a preprint problem 902 while creating a print job 202 and before sending the print job 202 to print devices 218.

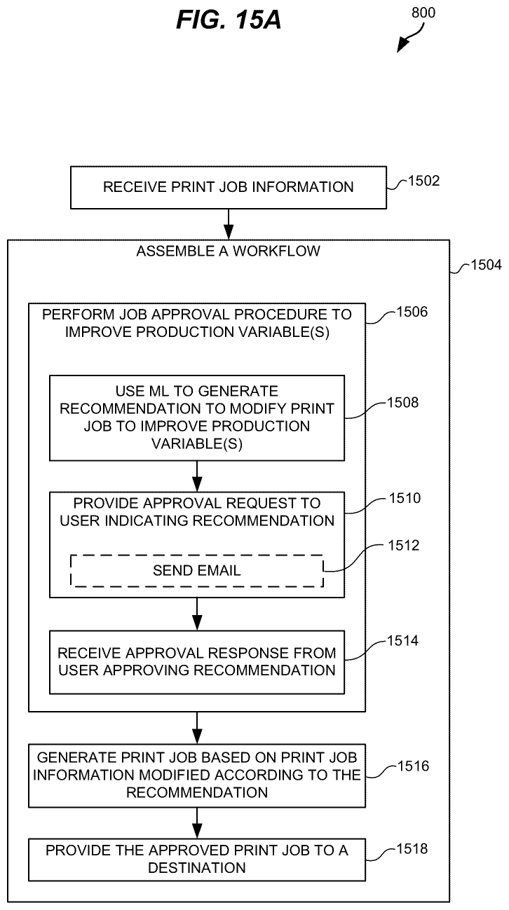

FIG. 13 is a schematic diagram illustrating training and deployment of machine learning models in an illustrative embodiment. An ML system 610 of print job manager 314 may operate in a training phase 1302, and a testing or deployment phase 1304. In the training phase 1302, ML trainer 612, for example, operates to train one or more machine-learning models. For example, ML trainer 612 may train a problem detection model 1016. ML trainer 612 performs training 1324 of the problem detection model 1016 using training samples 1312 of a training dataset 1310 to detect preprint problems 902 in print job information 702. ML trainer 612 may train a recommendation model 1216. ML trainer 612 performs training 1324 of the recommendation model 1216 using training samples 1313 of a training dataset 1311 to generate recommendations 724 to resolve preprint problems 902. During training 1324, ML trainer 612 may train the problem detection model 1016 and recommendation model 1216 over a plurality of epochs 1320, which is a single iteration of training on an entire training dataset. During an epoch 1320, problem detection model 1016 sequentially processes the training samples 1312 of the training dataset 1310, calculates loss or otherwise quantifies the predicted outputs, and updates model parameters 1318 (e.g., weights) accordingly. Likewise, recommendation model 1216 sequentially processes the training samples 1313 of the training dataset 1311, calculates loss or otherwise quantifies the predicted outputs, and updates model parameters 1318 accordingly. The number of epochs 1320 determines how many times the problem detection model 1016 and recommendation model 1216 iterate through the entire training dataset 1310-1311, allowing them to learn and refine the model parameters 1318 over multiple passes. Problem detection model 1016 and recommendation model 1216 are trained, within an epoch 1320, in batches 1322 of training samples 1312-1313 from the training datasets 1310-1311. A batch 1322 is a number of training samples to work through before updating model parameters 1318.

In the testing/deployment phase 1304, ML manager 614, for example, may use the trained problem detection model 1016 and the trained recommendation model 1216 to parse or analyze data. For example, ML manager 614 may feed print job information 702 into problem detection model 1016 (as trained), and problem detection model 1016 outputs an indication or prediction of a preprint problem 902, and may output an associated confidence score for the prediction. ML manager 614 may feed a preprint problem 902 and/or print job information 702 into recommendation model 1216 (as trained), and recommendation model 1216 outputs an indication or prediction of one or more recommendations 724 to resolve or correct a preprint problem 902, and may output an associated confidence score for the prediction. It is noted that problem detection model 1016 and recommendation model 1216 may be retrained on different or modified training datasets 1310-1311 as desired.

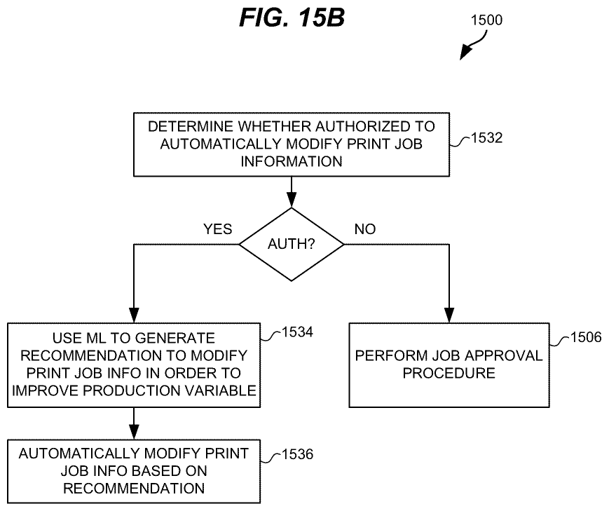

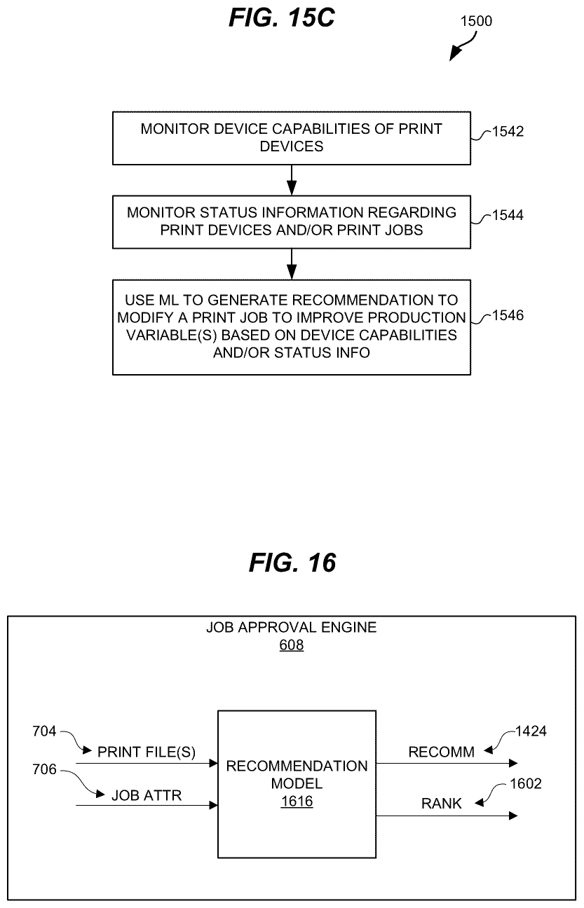

FIG. 14 is a message diagram illustrating communications between cloud printing service 210 and a user 242 in an illustrative embodiment. FIGS. 15A-15C are flow charts illustrating a method 1500 of handling a print job in an illustrative embodiment. The steps of method 1500 will be described with reference to print job manager 314 in FIG. 6, but those skilled in the art will appreciate that method 1500 may be performed in other systems or devices.

In operation, print job manager 314 receives print job information 702 submitted by a user 242 over a communication network 250 (see step 1502 in FIG. 15A). As illustrated in FIG. 14, print job manager 314 receives a job submission 720 comprising the print job information 702 in digital form from a client 240 operated by a user 242. For example, print job manager 314 may receive the print job information 702 in an email, via a transport protocol (e.g., FTP), through a customer portal 322, or through another means. The print job information 702 may comprise one or more print files 204, one or more print attributes 704 (also referred to as job attributes, print settings, etc.), and other job-related information. In response to receiving the print job information 702, print job manager 314 assembles a workflow 318 to create or generate a print job 202 based on the print job information 702 (see step 1504 of FIG. 15A).

When processing a print job 202 at one or more print devices 218, there are one or more production variables 1402 associated with processing the print job 202. In a print scenario, a production variable 1402 is a quantity that changes based on attributes of a print job 202. For example, a production variable 1402 may comprise a printing cost 1404, a turnaround time 1406, etc. Printing cost 1404 (also referred to as production cost) is the cost to perform printing, finishing, etc., of a print job 202 in producing a completed printed product. Turnaround time 1406 (also referred to as production turnaround) is the time (e.g., in hours, days, etc.) to perform printing, finishing, etc., of a print job 202 in producing a completed printed product. Printing cost 1404, for example, may depend on attributes or factors such as the printable media (e.g., type, size, etc.) selected for a print job, color or greyscale, types of finishing, etc. Turnaround time 1406, for example, may depend on attributes or factors such as availability of a printable media, availability of certain printers or finishing devices, etc.

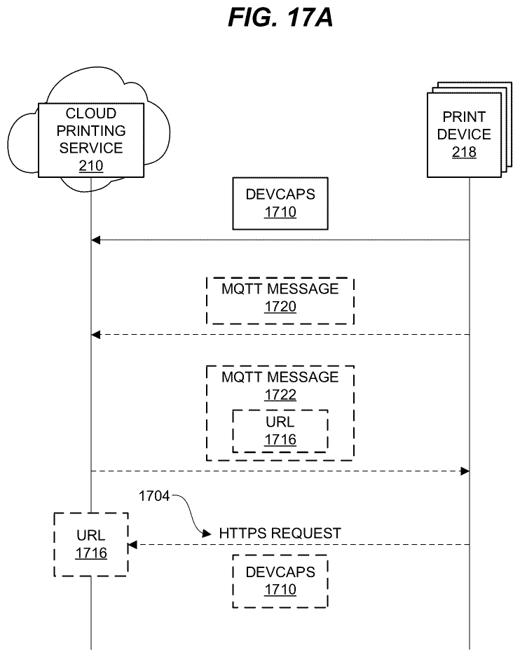

According to the workflow 318, print job manager 314 may trigger, initiate, or perform a job approval procedure 914 to improve or enhance one or more production variables 1402 (see step 1506 in FIG. 15A). For the job approval procedure 914 in FIG. 15A, print job manager 314 may operate a ML model 616 trained to generate a recommendation 1424 to change, alter, or modify the print job information 702 in order to improve a production variable(s) 1402 regarding printing of a print job 202 at one or more print devices 218 (see step 1508 in FIG. 15A). FIG. 16 is a block diagram of job approval engine 608 in an illustrative embodiment. A ML or AI model referred to as a recommendation model 1616 is trained to provide certain output based on input data. In an embodiment, the input data to the recommendation model 1616 may comprise at least a portion of the print job information 702 (e.g., print file(s) 204, print attributes 704, and/or other data). The (trained) recommendation model 1616 may generate, as output, a recommendation 1424 to modify the print job information 702 (e.g., modify one or more print attributes 704) in order to improve or enhance a production variable(s) 1402. In an embodiment, the recommendation 1424 may be based at least partially on historical data 623 for the user 242, historical data 625 for the producer 228, etc. One technical benefit is the cloud printing service 210 provides guidance to the user 242 as to how to improve a production variable 1402. In an embodiment, the (trained) recommendation model 1616 may generate, as output, a plurality of recommendations 1424 to modify the print job information 702 in order to improve a production variable(s) 1402. One technical benefit is the recommendation model 1616 may provide options to the user 242 as to how to improve a production variable 1402. In an embodiment, the (trained) recommendation model 1616 may generate, as output, rankings 1602 of the recommendations 1424. One technical benefit is the rankings 1602 may assist the user 242 in selecting a recommendation 1424.

Print job manager 314 provides or sends an approval request 722 to the user 242 (see step 1510 in FIG. 15A). The content of the approval request 722 may vary as desired. In an embodiment, the approval request 722 may indicate the recommendation 1424. In an embodiment, the approval request 722 may indicate a plurality of recommendations 1424. In an embodiment, the approval request 722 may indicate a plurality of recommendations 1424 and rankings 1602 of the recommendations 1424. When a print file 204 comprises a PDF file, for example, print job manager 314 may annotate the PDF file based on the recommendation(s) 1424, and provide the annotated PDF file to the user 242 with the approval request 722. In an embodiment, print job manager 314 may send an email 726 to the user 242 (optional step 1512 in FIG. 15A) containing the approval request 722, or comprising a link to a portal (e.g., customer portal 322) of the cloud printing service 210 configured to display the recommendation(s) 1424, the rankings 1602, and/or other data. One technical benefit of using email 726 for the approval request 722 is a consistent and reliable process is defined for interacting with a user 242 regarding submissions to the cloud printing service 210.

On their end, the user 242 may approve, reject, or modify the proposal in the approval request 722. Thus, the user 242 determines whether to accept a recommendation 1424 of the print job manager 314, whether to provide an alternate proposal, etc., and provides or sends an approval response 728 to the print job manager 314. The content of the approval response 728 may vary as desired. In an embodiment, the approval response 728 may indicate acceptance of a recommendation 1424 provided in an approval request 722. In an embodiment, the approval response 728 may indicate a selected recommendation 1424 from a plurality of recommendations 1424 provided in an approval request 722. In an embodiment, the approval response 728 may indicate an alternate proposal to modify the print job information 702. Although a single request/response exchange is illustrated in FIG. 14 as an example, there may be multiple exchanges between the user 242 and the print job manager 314 for a job approval procedure 914.

Print job manager 314 receives the approval response 728 from the user 242 (see step 1514 in FIG. 15A). After a recommendation 724 generated by the recommendation model 1616 is approved by the user 242, print job manager 314 generates, creates, or produces a print job 202 (i.e., an approved print job) based on print job information 702 modified according to the approved recommendation 1424 (see step 1516 in FIG. 15A). For example, print job manager 314 may change, modify, or alter the print file(s) 204, print attribute(s) 704, and/or other print job information 702 according to the approved recommendation 1424. In another example, the approval response 728 may contain modified print job information 702 modified by the user 242 according to the approved recommendation 1424, such as a modified print file(s) 204, print attribute(s) 704, and/or other print job information 702. Print job manager 314 (e.g., through ground interface 316) provides or sends the print job 202 to a destination corresponding with at least one of the print devices 218 over the communication network 250 (see step 1518 in FIG. 15A). The print job 202 may comprise one or more print files 204, a job ticket 706 (e.g., JDF job ticket or file) describing attributes for printing the print job 202 (e.g., media size, number of copies, color or greyscale, resolution, etc.), and/or other job-related information. For example, print job manager 314 may send a message to the destination comprising the print job 202, may load the print job 202 to a storage location associated with a URL, etc.

In an embodiment, print job manager 314 may automatically modify print job information 702 based on workflow rules 606 or job approval rules 618. In FIG. 15B, for example, print job manager 314 may determine whether it is authorized to automatically modify print job information 702 (see optional step 1532 in FIG. 15B). When authorized to automatically modify print job information 702, print job manager 314 may operate a recommendation model 1616 to generate a recommendation 1424 to modify the print job information 702 in order to improve a production variable(s) 1402 (see optional step 1534 in FIG. 15B), and automatically or autonomously to modify the print job information 702 based on the recommendation 1424 (see optional step 1536 in FIG. 15B), such as without further interaction with the user 242. When not authorized to automatically modify print job information 702, print job manager 314 performs a job approval procedure 914 to interact with the user 242 before modifying the print job information 702 (see step 1506 in FIGS. 15A-15B).

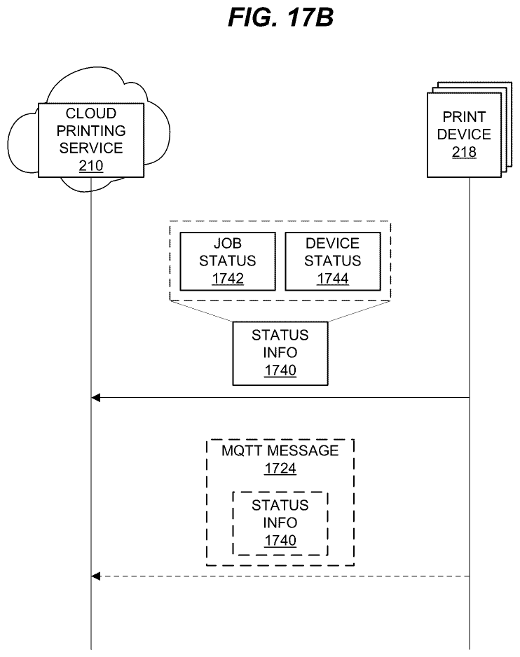

In an embodiment, print job manager 314 may generate the recommendation(s) 1424 based on information received from one or more of the print devices 218. FIGS. 17A-17B are message diagrams illustrating communications with a cloud printing service 210 in an illustrative embodiment. In FIG. 17A, one or more print devices 218 may send or provide device capabilities 1710 to the cloud printing service 210. Device capabilities 1710 (also referred to as device capability information or a device capabilities file) refers to a range of functionalities, features, and/or performance characteristics that a device possesses. For example, device capabilities 1710 for a printer 221-223 may include a printer manufacturer, a printer model, a serial number, printer resolution, print engine type (e.g., color or monochrome), printer speed, media types supported, media sizes supported, Page Description Languages (PDLs) supported (e.g., PostScript, Printer Command Languages (PCL), etc.), network protocols supported (e.g., TCP/IP, Line Printer Remote (LPR), Internet Printing Protocol (IPP), HyperText Transfer Protocol (HTTP), Simple Network Management Protocol (SNMP), etc.), page layouts supported (e.g., N-up), post-print or finishing activities supported (e.g., binding, cutting/trimming, embossing, laminating, etc.), and/or other capabilities or attributes.

In an embodiment, the cloud printing service 210 may use Message Queuing Telemetry Transport (MQTT) protocol for obtaining device capabilities 1710. For example, a print device 218 may send an MQTT message 1720 to the cloud printing service 210 requesting a URL 1716 for uploading the device capabilities 1710. Cloud printing service 210 may create or identify a URL 1716, and send the URL 1716 via an MQTT message 1722 that is received by the print device 218. The print device 218 may send an HTTPS request 1704 (e.g., HTTP PUT) to upload the device capabilities 1710 to a storage location accessible via the URL 1716.

In FIG. 17B, one or more print devices 218 may send or provide status information 1740 (also referred to as status updates) to the cloud printing service 210 regarding the status of print jobs 202, the status of printers 221-223 or print devices 218, etc. For example, status information 1740 may comprise a job status 1742 indicating details of printing a print job 202, a device status 1744 indicating an operating state of a print device 218, and/or other status information or updates. In an embodiment, a print device 218 may send one or more MQTT messages 1724 to the cloud printing service 210 with the status information 1740.

In FIG. 15C, print job manager 314 may monitor device capabilities 1710 of one or more of the print devices 218 (see optional step 1542 in FIG. 15C). For example, print job manager 314 may receive and store device capabilities 1710 provided by the print device(s) 218. Print job manager 314 may monitor status information 1740 regarding print devices 218 and/or print jobs 202 (see optional step 1544 in FIG. 15C). For example, print job manager 314 may receive and store status information 1740 provided by the print device(s) 218. Print job manager 314 may then operate a recommendation model 1616 to generate a recommendation 1424 to modify print job information 702 in order to improve a production variable(s) 1402 based on at least one of the device capabilities 1710 and the status information 1740 (see optional step 1546 in FIG. 15C). For example, assume that print attributes 704 specify printing of a print file 204 on glossy A4 paper. If the device capabilities 1710 or the status information 1740 indicates that a printer capable of printing on glossy A4 paper will not be available at a print shop for three days, for example, then print job manager 314 may generate a recommendation 1424 to modify the print job information 702 to regular A4 paper to improve turnaround time 1406. In another example, assume that print attributes 704 specify foil stamping as a finishing process for a print file 204. If the device capabilities 1710 or the status information 1740 indicates that an embossing device is available at a print shop, for example, then print job manager 314 may generate a recommendation 1424 to modify the print job information 702 to embossing instead of foil stamping to reduce the printing cost 1404 of a print job 202 (assuming embossing is less expensive than foil stamping).

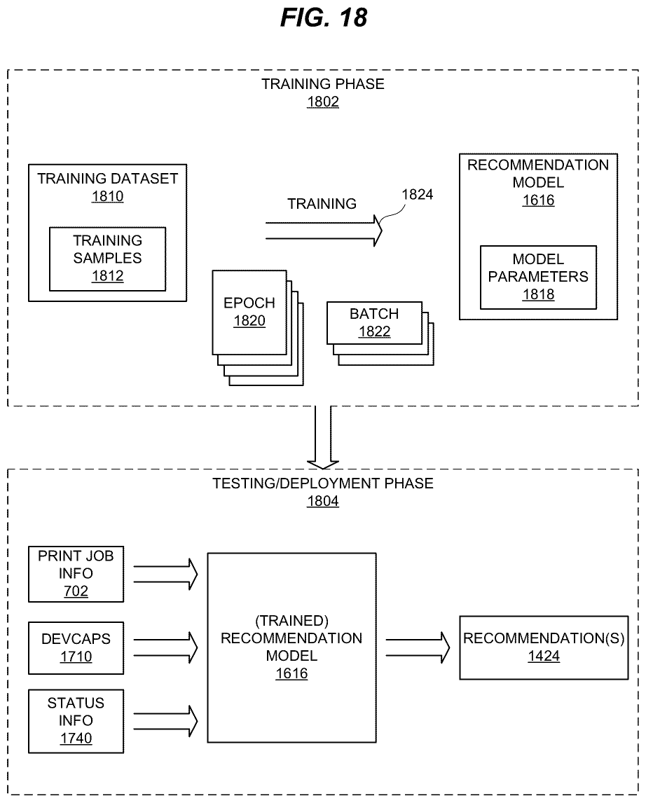

FIG. 18 is a schematic diagram illustrating training and deployment of machine learning models in an illustrative embodiment. An ML system 610 of print job manager 314 may operate in a training phase 1802, and a testing or deployment phase 1804. In the training phase 1802, ML trainer 612, for example, operates to train one or more machine-learning models. For example, ML trainer 612 may train a recommendation model 1616. ML trainer 612 performs training 1824 of the recommendation model 1616 using training samples 1812 of a training dataset 1810 to generate recommendations to modify print job information in order to improve or enhance production variables. During training 1824, ML trainer 612 may train the recommendation model 1616 over a plurality of epochs 1820, which is a single iteration of training on an entire training dataset. During an epoch 1820, recommendation model 1616 sequentially processes the training samples 1812 of the training dataset 1810, calculates loss or otherwise quantifies the predicted outputs, and updates model parameters 1818 accordingly. The number of epochs 1820 determines how many times the recommendation model 1616 iterates through the entire training dataset 1810, allowing it to learn and refine the model parameters 1818 over multiple passes. Recommendation model 1616 is trained, within an epoch 1820, in batches 1822 of training samples 1812 from the training dataset 1810. A batch 1822 is a number of training samples to work through before updating model parameters 1818.

In the testing/deployment phase 1804, ML manager 614, for example, may use the trained recommendation model 1616 to parse or analyze data. For example, ML manager 614 may feed print job information 702, device capabilities 1710, status information 1740, and/or other data into recommendation model 1616 (as trained), and recommendation model 1616 outputs one or more recommendations 1424 to modify print job information 702 in order to improve or enhance production variables 1402. It is noted that recommendation model 1616 may be retrained on a different or modified training dataset 1810 as desired.

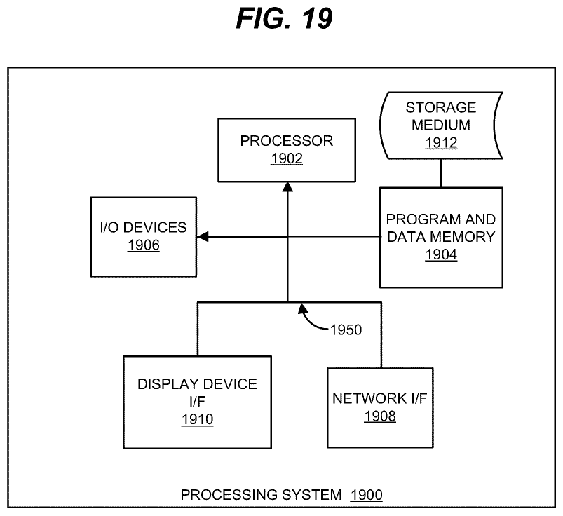

Embodiments disclosed herein can take the form of software, hardware, firmware, or various combinations thereof. FIG. 19 illustrates a processing system 1900 operable to execute a computer readable medium embodying programmed instructions to perform desired functions in an illustrative embodiment. Processing system 1900 is operable to perform the above operations by executing programmed instructions tangibly embodied on computer readable storage medium 1912. In this regard, embodiments can take the form of a computer program accessible via computer-readable medium 1912 providing program code for use by a computer or any other instruction execution system. For the purposes of this description, computer readable storage medium 1912 can be anything that can contain or store the program for use by the computer.

Computer readable storage medium 1912 can be an electronic, magnetic, optical, electromagnetic, infrared, or semiconductor device. Examples of computer readable storage medium 1912 include a solid-state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 1900, being suitable for storing and/or executing the program code, includes at least one processor 1902 coupled to program and data memory 1904 through a system bus 1950. Program and data memory 1904 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1906 (including but not limited to keyboards, displays, pointing devices, etc.) can be coupled either directly or through intervening I/O controllers. Network adapter interfaces 1908 may also be integrated with the system to enable processing system 1900 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 1910 may be integrated with the system to interface to one or more display devices, such as printing systems and screens for presentation of data generated by processor 1902.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes an apparatus comprising a print job manager of a cloud printing service provisioned on a cloud-computing platform, the print job manager comprising at least one processor and memory configured to cause the print job manager at least to receive print job information submitted by a user over a communication network, perform preprint processing on the print job information to detect a preprint problem, and perform a job approval procedure to interact with the user to resolve the preprint problem. The job approval procedure comprises operating at least one machine-learning model trained to generate a recommendation to resolve the preprint problem, providing an approval request to the user indicating the preprint problem and the recommendation to resolve the preprint problem generated by the at least one machine-learning model, and receiving an approval response from the user approving the recommendation generated by the at least one machine-learning model. The at least one processor and memory are further configured to cause the print job manager at least to generate a print job based on the print job information modified according to the recommendation approved by the user, and provide the print job to a destination corresponding with at least one print device over the communication network.

Example 2 includes the subject matter of Example 1, where the providing of the approval request to the user comprises sending an email to the user comprising a link to a portal of the cloud printing service configured to display the recommendation.

Example 3 includes the subject matter of Examples 1 and 2, where the at least one processor and memory are further configured to cause the print job manager at least to operate the at least one machine-learning model trained to detect the preprint problem in the print job information.

Example 4 includes the subject matter of Examples 1-3, where print attributes of the print job information include free-form text specified by the user, and the at least one processor and memory are further configured to cause the print job manager at least to operate the at least one machine-learning model to interpret the free-form text.

Example 5 includes the subject matter of Examples 1-4, where the at least one processor and memory are further configured to cause the print job manager at least to determine whether the print job manager is authorized to automatically correct the preprint problem, perform the job approval procedure when the print job manager is not authorized to automatically correct the preprint problem, and when the print job manager is authorized to automatically correct the preprint problem operate the at least one machine-learning model trained to generate the recommendation to resolve the preprint problem, and automatically correct the preprint problem based on the recommendation generated by the at least one machine-learning model.

Example 6 includes the subject matter of Examples 1-5, where the operating comprises operating the at least one machine-learning model trained to generate a plurality of recommendations to resolve the preprint problem, and to generate rankings of the recommendations. The providing of the approval request to the user comprises providing the approval request indicating the preprint problem, the recommendations to resolve the preprint problem, and the rankings of the recommendations.

Example 7 includes the subject matter of Examples 1-6, where the receiving of the approval response from the user comprises receiving the approval response indicating a selected one of the recommendations.

Example 8 includes the subject matter of Examples 1-7, where a print file of the print job information comprises a Portable Document Format (PDF) file, and the at least one processor and memory are further configured to cause the print job manager at least to annotate the PDF file based on the recommendation from the at least one machine-learning model.

Example 9 includes the subject matter of Examples 1-8, where the at least one processor and memory are further configured to cause the print job manager at least to modify the print job information based on the recommendation approved by the user to generate the print job.

Example 10 includes the subject matter of Examples 1-9, where the at least one processor and memory are further configured to cause the print job manager at least to perform training of the at least one machine-learning model based on training samples of a training dataset to generate recommendations to resolve preprint problems.

Some embodiments pertain to Example 11 that includes a method, in a cloud print service provisioned on a cloud-computing platform, comprising: receiving print job information submitted by a user over a communication network, performing preprint processing on the print job information to detect a preprint problem, and performing a job approval procedure to interact with the user to resolve the preprint problem. The job approval procedure comprises operating at least one machine-learning model trained to generate a recommendation to resolve the preprint problem, providing an approval request to the user indicating the preprint problem and the recommendation to resolve the preprint problem generated by the at least one machine-learning model, and receiving an approval response from the user approving the recommendation generated by the at least one machine-learning model. The method further comprises generating a print job based on the print job information modified according to the recommendation approved by the user, and providing the print job to a destination corresponding with at least one print device over the communication network.

Example 12 includes the subject matter of Example 11, where the providing of the approval request to the user comprises sending an email to the user comprising a link to a portal of the cloud printing service configured to display the recommendation.

Example 13 includes the subject matter of Examples 11 and 12, further comprising operating the at least one machine-learning model trained to detect the preprint problem in the print job information.

Example 14 includes the subject matter of Examples 11-13, where print attributes of the print job information include free-form text specified by the user, and the method further comprises operating the at least one machine-learning model to interpret the free-form text.

Example 15 includes the subject matter of Examples 11-14, further comprising when authorized to automatically correct the preprint problem, operating the at least one machine-learning model trained to generate the recommendation to resolve the preprint problem, and automatically correcting the preprint problem based on the recommendation generated by the at least one machine-learning model.

Example 16 includes the subject matter of Examples 11-15, where the operating comprises operating the at least one machine-learning model trained to generate a plurality of recommendations to resolve the preprint problem, and to generate rankings of the recommendations. The providing of the approval request to the user comprises providing the approval request indicating the preprint problem, the recommendations to resolve the preprint problem, and the rankings of the recommendations.

Example 17 includes the subject matter of Examples 11-16, where the receiving of the approval response from the user comprises receiving the approval response indicating a selected one of the recommendations.

Example 18 includes the subject matter of Examples 11-17, further comprising modifying the print job information based on the recommendation approved by the user to generate the print job.

Example 19 includes the subject matter of Examples 11-18, further comprising performing training of the at least one machine-learning model based on training samples of a training dataset to generate recommendations to resolve preprint problems.

Some embodiments pertain to Example 20 that includes a non-transitory computer readable medium embodying programmed instructions executed by a processor, where the instructions direct the processor to implement a method of handling print jobs. The method, in a cloud print service provisioned on a cloud-computing platform, comprises: receiving print job information submitted by a user over a communication network, performing preprint processing on the print job information to detect a preprint problem, and performing a job approval procedure to interact with the user to resolve the preprint problem. The job approval procedure comprises operating at least one machine-learning model trained to generate a recommendation to resolve the preprint problem, providing an approval request to the user indicating the preprint problem and the recommendation to resolve the preprint problem generated by the at least one machine-learning model, and receiving an approval response from the user approving the recommendation generated by the at least one machine-learning model. The method comprises generating a print job based on the print job information modified according to the recommendation approved by the user, and providing the print job to a destination corresponding with at least one print device over the communication network.

Although specific embodiments were described herein, the scope of the invention is not limited to those specific embodiments. The scope of the invention is defined by the following claims and any equivalents thereof.

What is claimed is:

1. An apparatus, comprising:
a print job manager of a cloud printing service provisioned on a cloud-computing platform, the print job manager comprising at least one processor and memory configured to cause the print job manager at least to:
receive print job information submitted by a user over a communication network;
perform preprint processing on the print job information to detect a preprint problem;
perform a job approval procedure to interact with the user to resolve the preprint problem by:
operating at least one machine-learning model trained to generate a recommendation to resolve the preprint problem;
providing an approval request to the user indicating the preprint problem and the recommendation to resolve the preprint problem generated by the at least one machine-learning model; and
receiving an approval response from the user approving the recommendation generated by the at least one machine-learning model;
generate a print job based on the print job information modified according to the recommendation approved by the user; and
provide the print job to a destination corresponding with at least one print device over the communication network.

2. The apparatus of claim 1, wherein:
the providing of the approval request to the user comprises sending an email to the user comprising a link to a portal of the cloud printing service configured to display the recommendation.

3. The apparatus of claim 1, wherein the at least one processor and memory are further configured to cause the print job manager at least to:
operate the at least one machine-learning model trained to detect the preprint problem in the print job information.

4. The apparatus of claim 1, wherein:
print attributes of the print job information include free-form text specified by the user; and
the at least one processor and memory are further configured to cause the print job manager at least to operate the at least one machine-learning model to interpret the free-form text.

5. The apparatus of claim 1, wherein the at least one processor and memory are further configured to cause the print job manager at least to:
determine whether the print job manager is authorized to automatically correct the preprint problem;
perform the job approval procedure when the print job manager is not authorized to automatically correct the preprint problem; and
when the print job manager is authorized to automatically correct the preprint problem:
operate the at least one machine-learning model trained to generate the recommendation to resolve the preprint problem; and
automatically correct the preprint problem based on the recommendation generated by the at least one machine-learning model.

6. The apparatus of claim 1, wherein:
the operating comprises operating the at least one machine-learning model trained to generate a plurality of recommendations to resolve the preprint problem, and to generate rankings of the recommendations; and
the providing of the approval request to the user comprises providing the approval request indicating the preprint problem, the recommendations to resolve the preprint problem, and the rankings of the recommendations.

7. The apparatus of claim 6, wherein:
the receiving of the approval response from the user comprises receiving the approval response indicating a selected one of the recommendations.

8. The apparatus of claim 1, wherein:
a print file of the print job information comprises a Portable Document Format (PDF) file; and
the at least one processor and memory are further configured to cause the print job manager at least to:
annotate the PDF file based on the recommendation from the at least one machine-learning model.

9. The apparatus of claim 1, wherein the at least one processor and memory are further configured to cause the print job manager at least to:
modify the print job information based on the recommendation approved by the user to generate the print job.

10. The apparatus of claim 1, wherein the at least one processor and memory are further configured to cause the print job manager at least to:
perform training of the at least one machine-learning model based on training samples of a training dataset to generate recommendations to resolve preprint problems.

11. A method comprising:
in a cloud print service provisioned on a cloud-computing platform:
receiving print job information submitted by a user over a communication network;
performing preprint processing on the print job information to detect a preprint problem;
performing a job approval procedure to interact with the user to resolve the preprint problem by:
operating at least one machine-learning model trained to generate a recommendation to resolve the preprint problem;
providing an approval request to the user indicating the preprint problem and the recommendation to resolve the preprint problem generated by the at least one machine-learning model; and
receiving an approval response from the user approving the recommendation generated by the at least one machine-learning model;
generating a print job based on the print job information modified according to the recommendation approved by the user; and
providing the print job to a destination corresponding with at least one print device over the communication network.

12. The method of claim 11, wherein:
the providing of the approval request to the user comprises sending an email to the user comprising a link to a portal of the cloud printing service configured to display the recommendation.

13. The method of claim 11, further comprising:
operating the at least one machine-learning model trained to detect the preprint problem in the print job information.

14. The method of claim 11, wherein:
print attributes of the print job information include free-form text specified by the user; and
the method further comprises:
operating the at least one machine-learning model to interpret the free-form text.

15. The method of claim 11, further comprising:
when authorized to automatically correct the preprint problem:
operating the at least one machine-learning model trained to generate the recommendation to resolve the preprint problem; and
automatically correcting the preprint problem based on the recommendation generated by the at least one machine-learning model.

16. The method of claim 11, wherein:
the operating comprises operating the at least one machine-learning model trained to generate a plurality of recommendations to resolve the preprint problem, and to generate rankings of the recommendations; and
the providing of the approval request to the user comprises providing the approval request indicating the preprint problem, the recommendations to resolve the preprint problem, and the rankings of the recommendations.

17. The method of claim 16, wherein:
the receiving of the approval response from the user comprises receiving the approval response indicating a selected one of the recommendations.

18. The method of claim 11, further comprising:
modifying the print job information based on the recommendation approved by the user to generate the print job.

19. The method of claim 11, further comprising:
performing training of the at least one machine-learning model based on training samples of a training dataset to generate recommendations to resolve preprint problems.

20. A non-transitory computer readable medium embodying programmed instructions executed by a processor, wherein the instructions direct the processor to implement a method of handling print jobs, the method comprising:
in a cloud print service provisioned on a cloud-computing platform:
receiving print job information submitted by a user over a communication network;
performing preprint processing on the print job information to detect a preprint problem;
performing a job approval procedure to interact with the user to resolve the preprint problem by:
operating at least one machine-learning model trained to generate a recommendation to resolve the preprint problem;
providing an approval request to the user indicating the preprint problem and the recommendation to resolve the preprint problem generated by the at least one machine-learning model; and
receiving an approval response from the user approving the recommendation generated by the at least one machine-learning model;
generating a print job based on the print job information modified according to the recommendation approved by the user; and
providing the print job to a destination corresponding with at least one print device over the communication network.
